(19) United States
(12) Patent Application Publication
(10) Pub. No.: US 2023/0328540 A1
(43) Pub. Date: Oct. 12, 2023

(54) WIRELESS COMMUNICATION SYSTEM, COMMUNICATION CONTROL DEVICE, AND COMMUNICATION DEVICE

(71) Applicant: Fujitsu Limited, Kawasaki-shi (JP)

(72) Inventor: Teppei OYAMA, Kawasaki (JP)

(73) Assignee: Fujitsu Limited, Kawasaki-shi (JP)

(21) Appl. No.: 18/084,646

(22) Filed: Dec. 20, 2022

(30) Foreign Application Priority Data
Mar. 23, 2022 (JP) 2022-046603

(51) Int. Cl. H04W 72/0446; H04W 16/28

(52) U.S. Cl. CPC H04W 16/28; H04W 72/0446

(57) ABSTRACT

A wireless communication system includes a wireless communication device that is capable of forming a plurality of beams each facing a different direction, and a communication control device that controls the wireless communication device. The communication control device includes a processor that executes a process including acquiring distribution information that indicates a distribution of terminal devices that perform wireless communication with the wireless communication device, deciding, based on the acquired distribution information, allocation time that is allocated to each of the plurality of beams, and generating beam time information that indicates the decided allocation time for each beam, and a transmitter that transmits the beam time information generated by the processor to the wireless communication device.

### CROSS-REFERENCE TO RELATED APPLICATION

This application is based upon and claims the benefit of priority of the prior Japanese Pat. Application No. 2022-046603, filed on Mar. 23, 2022, the entire contents of which are incorporated herein by reference.

### FIELD

The embodiments discussed herein are related to a wireless communication system, a communication control device, and a communication device.

### BACKGROUND

In recent years, in wireless communication systems, services using the fifth generation mobile unit communication (5G) capable of performing high-speed and large-capacity data communication are being introduced. In services using 5G, for example, radio waves, such as millimeter waves, having frequencies higher than those used in Long Term Evolution (LTE) or the like are used. The radio waves at such high frequencies have straightness characteristics and are less likely to pass through shielding objects, so that a radius of a cell tends to be smaller. Consequently, in order to construct wireless communication systems, there is a need to install base station devices at high densities.

Specifically, base station devices are split into, for example, baseband devices (i.e., central unit/distributed unit: CU/DU) that perform a baseband process and wireless devices (i.e., radio unit: RU) that perform a wireless process, so that the RUs having antennas are disposed at high densities. Accordingly, telecommunications carriers (i.e., mobile network operator: MNO) that construct wireless communication systems are able to efficiently expand communication areas and system capacity by installing RUs that can be shared in cooperation with other MNOs.

Patent Document 1: Japanese Laid-open Pat. Publication No. 2017-135686

### SUMMARY

According to an aspect of an embodiment, a wireless communication system includes a wireless communication device that is capable of forming a plurality of beams each facing a different direction, and a communication control device that controls the wireless communication device. The communication control device includes a processor that executes a process including acquiring distribution information that indicates a distribution of terminal devices that perform wireless communication with the wireless communication device, deciding, based on the acquired distribution information, allocation time that is allocated to each of the plurality of beams, and generating beam time information that indicates the decided allocation time for each beam, and a transmission unit that transmits the beam time information generated by the processor to the wireless communication device.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a configuration of a wireless communication system;

FIG. 2 is a block diagram illustrating a configuration of a CU/DU;

FIG. 3 is a block diagram illustrating a configuration of a shared RU;

FIG. 4 is a block diagram illustrating a configuration of a shared control device according to a first embodiment;

FIG. 5 is a sequence diagram illustrating a communication method;

FIG. 6 is a flowchart illustrating a beam allocation decision process according to the first embodiment;

FIG. 7 is a diagram illustrating a specific example of beam allocation;

FIG. 8 is a flowchart illustrating a beam allocation decision process according to a second embodiment;

FIG. 9 is a flowchart continued from FIG. 8;

FIG. 10 is a diagram illustrating a specific example of beam allocation;

FIG. 11 is a flowchart illustrating a beam allocation decision process according to a third embodiment;

FIG. 12 is a flowchart continued from FIG. 11; and

FIG. 13 is a block diagram illustrating a modification of the shared control device.

### DESCRIPTION OF EMBODIMENTS

However, in the case where a plurality of MNOs share a RU, there is a problem in that the size of the RU is increased. Specifically, the RU (hereinafter, referred to as a “shared RU”) that is shared by the plurality of MNOs includes circuits each of which performs a process on transmission signals sent from these MNOs. From among these circuits, for example, a power amplifier or the like is able to be used in common with respect to the transmission signals sent from the plurality of MNOs, whereas, for example, it is difficult to use, in common, a phase shifter or the like that is used for beamforming with respect to the transmission signals sent from the plurality of MNOs.

In other words, the transmission signals sent from the respective MNOs are sometimes transmitted by beams each facing a different direction, and, in order to simultaneously transmit these transmission signals, a beam for transmitting a transmission signal associated with each of the MNOs is formed by a phase shifter installed in each of the MNOs. As a result, the shared RU needs to include the phase shifter associated with each of the plurality of MNOs, which leads to an increase in the size of the device.

Preferred embodiments will be explained with reference to accompanying drawings. The present disclosure is not limited to the embodiments.

### [A] First Embodiment

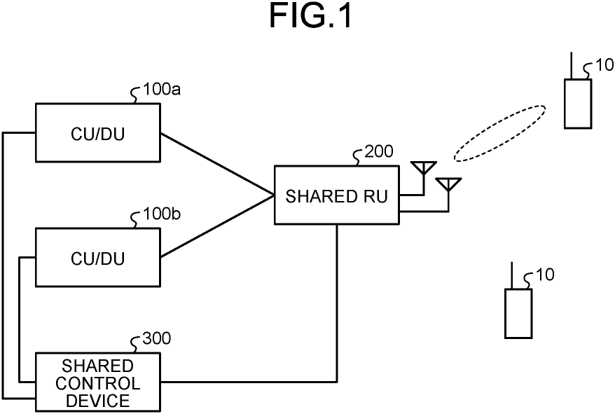

FIG. 1 is a diagram illustrating an example of a configuration of a wireless communication system according to a first embodiment. In the wireless communication system illustrated in FIG. 1, a plurality of CU/DUs 100a and 100b that are managed by different MNOs share a shared RU 200. That is, each of the CU/DUs 100a and 100b is connected to the shared RU 200 via a front-haul line (FH line). Furthermore, the CU/DUs 100a and 100b and the shared RU 200 are connected to a shared control device 300.

The CU/DUs 100a and 100b are baseband devices that constitutes a base station. Each of the CU/DUs 100a and 100b is connected to a core network for each MNO (not illustrated), and performs baseband process on a signal for each MNO. Furthermore, each of the CU/DUs 100a and 100b is connected to the shared RU 200 via the FH line, and acquires information on user terminals (UE :User Equipment) 10 that perform wireless communication with the shared RU 200 and that are managed by the own MNO. Then, each of the CU/DUs 100a and 100b notifies the shared control device 300 of the acquired information on the UEs 10. An example of the information on the UEs 10 includes UE distribution information that indicates, for each of beams that are formed by the shared RU 200, the number of UEs 10 that are managed by the own MNO and that are located in the respective directions of the beams.

Furthermore, each of the CU/DUs 100a and 100b acquires, from the shared control device 300, beam time information related to time at which the shared RU 200 forms a beam facing in each of the directions, and performs scheduling on each of the UEs 10 managed by the own MNO on the basis of the beam time information.

The shared RU 200 is a wireless device that constitutes a base station. The shared RU 200 is connected to the plurality of CU/DUs 100a and 100b that are associated with the plurality of respective MNOs, and performs a wireless process on a signal. That is, the shared RU 200 wirelessly transmits and receives a signal to and from each of the UEs 10 that are included in a cell. At this time, the shared RU 200 acquires, from the shared control device 300, the beam time information related to time at which the beam facing in each of the directions is formed, forms a beam in accordance with the beam time information, and transmits a signal addressed to each of the UEs 10.

The UE 10 is a terminal device that is capable of performing wireless communication. The UE 10 performs wireless communication with the shared RU 200 that forms a cell in which the own device is present. The UE 10 is managed by one of the MNOs from among the plurality of MNOs that share the shared RU 200, and transmits and receives a signal to and from the CU/DUs 100a and 100b associated with the MNO.

The shared control device 300 acquires, from the CU/DUs 100a and 100b, the UE distribution information that indicates a distribution of the UEs 10 that are located in the respective directions of the beams formed by the shared RU 200, and decides allocation time that is allocated to each of the beams. Then, the shared control device 300 generates the beam time information that indicates the allocation time allocated to each of the beams, and notifies the CU/DUs 100a and 100b and the shared RU 200 of the beam time information. A configuration and an operation of the shared control device 300 will be described in detail later.

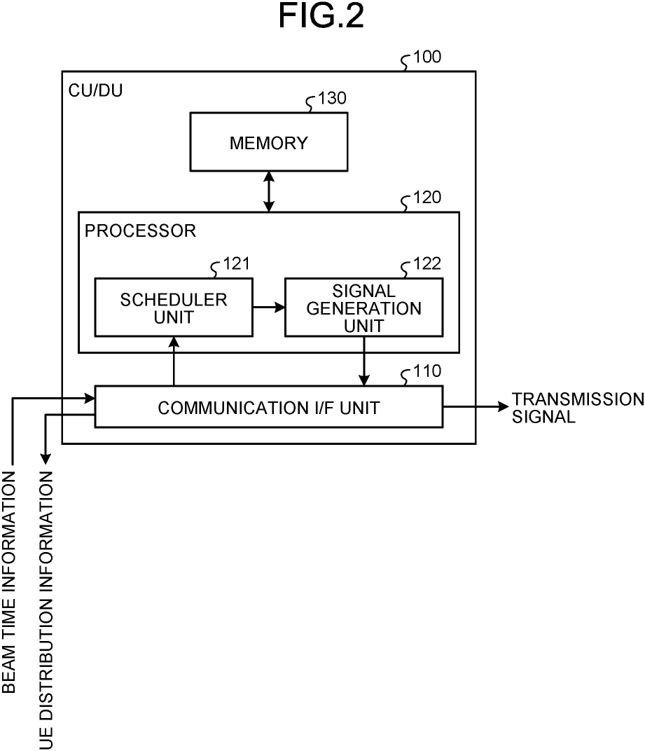

FIG. 2 is a block diagram illustrating a configuration of a CU/DU 100. The CU/DU 100 has the same configuration as that of the CU/DUs 100a and 100b. The CU/DU 100 illustrated in FIG. 2 includes a communication interface unit (hereinafter, simply referred to as a “communication I/F unit”) 110, a processor 120, and a memory 130.

The communication I/F unit 110 is an interface for performing communication with the shared RU 200 and the shared control device 300. The communication I/F unit 110 transmits, to the shared RU 200, a transmission signal addressed to the UE 10 that is managed by the own MNO. Furthermore, the communication I/F unit 110 transmits, to the shared control device 300, the UE distribution information on the UE 10 that is managed by the own MNO, and receives the beam time information from the shared control device 300.

The processor 120 includes, for example, a central processing unit (CPU), a field programmable gate array (FPGA), a digital signal processor (DSP), or the like, and performs overall control of the CU/DU 100. Specifically, the processor 120 includes a scheduler unit 121 and a signal generation unit 122.

The scheduler unit 121 performs, on the basis of the beam time information received by the communication I/F unit 110, scheduling of a timing at which a signal addressed to the UE 10 that is managed by the own MNO is transmitted. Specifically, the scheduler unit 121 grasps slots in each of which the beam in direction is formed by referring to the beam time information, and performs scheduling in the slots in each of which the beam is formed such that a signal addressed to the UE 10 that is located in the direction of the subject beam is transmitted.

Furthermore, the scheduler unit 121 specifies the direction of an optimum beam for each of the UEs 10 that are managed by the own MNO, generates the UE distribution information that indicates the number of UEs 10 for each beam, and transmits the generated UE distribution information from the communication I/F unit 110 to the shared control device 300.

The signal generation unit 122 generates a signal addressed to the UE 10 in accordance with the result of the scheduling performed by the scheduler unit 121. Then, the signal generation unit 122 allows the communication I/F unit 110 to transmit the transmission signal addressed to the UE 10 to the shared RU 200.

The memory 130 includes, for example, a random access memory (RAM), a read only memory (ROM), or the like, and stores information that is used for a process performed by the processor 120.

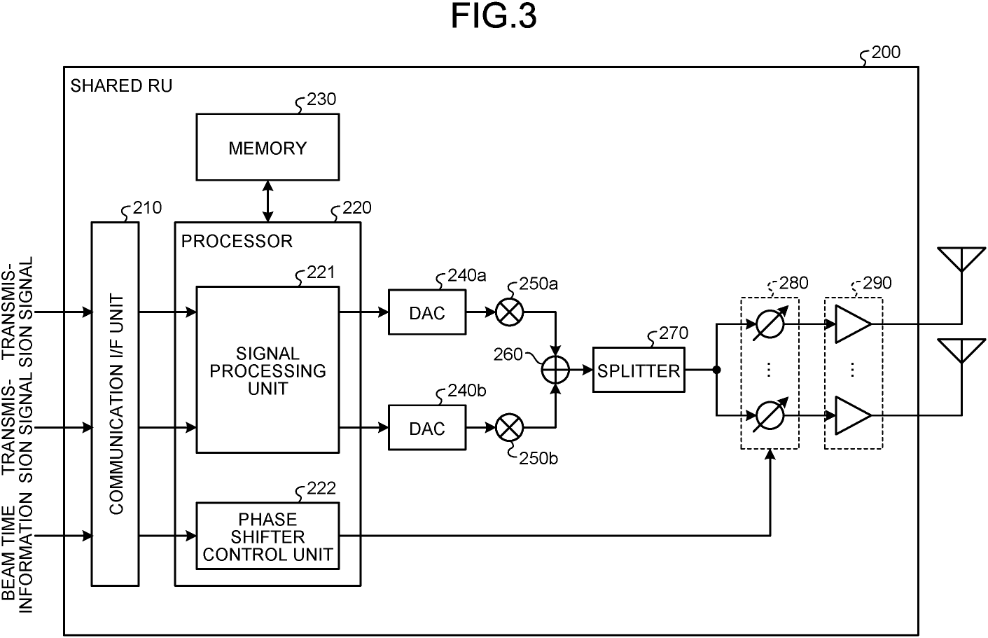

FIG. 3 is a block diagram illustrating a configuration of the shared RU 200. The shared RU 200 illustrated in FIG. 3 includes a communication I/F unit 210, a processor 220, a memory 230, digital analog converters (DACs) 240a and 240b, up-converters 250a and 250b, a combiner 260, a splitter 270, a phase shifter 280, and a power amplifier 290.

The communication I/F unit 210 is an interface for performing communication with the CU/DUs 100a and 100b and the shared control device 300. The communication I/F unit 210 receives a transmission signal sent from each of the MNOs from the CU/DUs 100a and 100b. These transmission signals are the signals addressed to the respective UEs 10 managed by each of the MNOs. Furthermore, the communication I/F unit 210 receives the beam time information that indicates the allocation time allocated to each of the beams from the shared control device 300.

The processor 220 includes, for example, a CPU, an FPGA, a DSP, or the like, and performs overall control of the shared RU 200. Specifically, the processor 220 includes a signal processing unit 221 and a phase shifter control unit 222.

The signal processing unit 221 performs, on the transmission signal addressed to the UE 10 sent from each of the MNOs, signal processing, such as a distortion compensation process for compensating nonlinear distortion that is generated in, for example, the power amplifier 290. Then, the signal processing unit 221 outputs the transmission signal transmitted from the CU/DU 100a to the DAC 240a, and outputs the transmission signal transmitted from the CU/DU 100b to the DAC 240b.

The phase shifter control unit 222 acquires the beam time information received by the communication I/F unit 210, and controls the phase shifter 280 in accordance with the beam time information. Specifically, the phase shifter control unit 222 sets an amount of phase rotation of the phase shifter 280 that is associated with a plurality of respective antenna elements such that each of the beams is formed in accordance with the allocation time for each beam indicated by the beam time information.

The memory 230 includes, for example, a RAM, a ROM, or the like, and stores information that is used for the process performed by the processor 220.

Each of the DACs 240a and 240b performs digital analog (DA) conversion on a transmission signal addressed to each of the UEs 10 managed by the respective MNOs. That is, the DAC 240a performs DA conversion on the transmission signal transmitted from the CU/DU 100a, and the DAC 240b performs DA conversion on the transmission signal transmitted from the CU/DU 100b.

Each of the up-converters 250a and 250b performs up-conversion on the transmission signal addressed to each of the UEs 10 managed by the respective MNOs. That is, the up-converter 250a performs up-conversion on the transmission signal transmitted from the CU/DU 100a, and the up-converter 250b performs up-conversion on the transmission signal transmitted from the CU/DU 100b.

The combiner 260 combines the transmission signals addressed to the UEs 10 managed by the respective MNOs. That is, the combiner 260 combines the transmission signal transmitted from the CU/DU 100a and the transmission signal transmitted from the CU/DU 100b.

The splitter 270 distributes the transmission signal that is obtained by being combined by the combiner 260 to a plurality of antenna elements.

The phase shifter 280 is provided in each of the plurality of antenna elements, and adds a phase rotation to the transmission signal that has been distributed to each of the antenna elements, so that the phase shifter 280 sets a phase difference to the transmission signal among the antenna elements and forms beams. The phase shifter 280 adds a phase rotation to the transmission signal associated with each of the antenna elements in accordance with control performed by the phase shifter control unit 222, and forms beams in accordance with the beam time information.

The power amplifier 290 is provided in each of the plurality of antenna elements, and amplifies the transmission signal distributed to each of the antenna elements. Then, the power amplifier 290 wirelessly transmits the amplified transmission signal from each of the antenna elements.

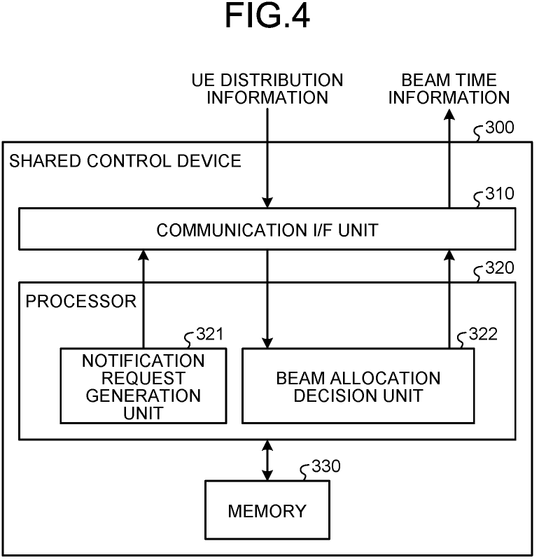

FIG. 4 is a block diagram illustrating a configuration of the shared control device 300 according to the first embodiment. The shared control device 300 illustrated in FIG. 4 includes a communication I/F unit 310, a processor 320, and a memory 330.

The communication I/F unit 310 is an interface for performing communication with the CU/DUs 100a and 100b and the shared RU 200. The communication I/F unit 310 receives the UE distribution information on each of the MNOs from the CU/DUs 100a and 100b. Furthermore, the communication I/F unit 310 transmits the beam time information to the CU/DUs 100a and 100b and the shared RU 200.

The processor 320 includes, for example, a CPU, an FPGA, a DSP, or the like, and performs overall control of the shared control device 300. Specifically, the processor 320 includes a notification request generation unit 321 and a beam allocation decision unit 322.

The notification request generation unit 321 generates a notification request that requests the CU/DUs 100a and 100b associated with each of the MNOs to notify the UE distribution information. Then, the notification request generation unit 321 transmits the notification request from the communication I/F unit 310, and requests the CU/DUs 100a and 100b to send the UE distribution information.

When the UE distribution information associated with each of the MNOs is received by the communication I/F unit 310, the beam allocation decision unit 322 decides allocation time to be allocated to each of the beams formed by the shared RU 200 in accordance with the distribution of the UEs 10. Specifically, the beam allocation decision unit 322 increases the allocation time to be allocated to the beam in the direction in which a larger number of UEs 10 are present, and lengthen the period of time for which a transmission signal addressed to a larger number of the UEs 10 is able to be transmitted. Then, the beam allocation decision unit 322 generates the beam time information that indicates the allocation time for each beam, and allows the communication I/F unit 310 to transmit the generated beam time information to the CU/DUs 100a and 100b and the shared RU 200.

The memory 330 includes, for example, a RAM, a ROM, or the like, and stores information that is used for a process performed by the processor 320.

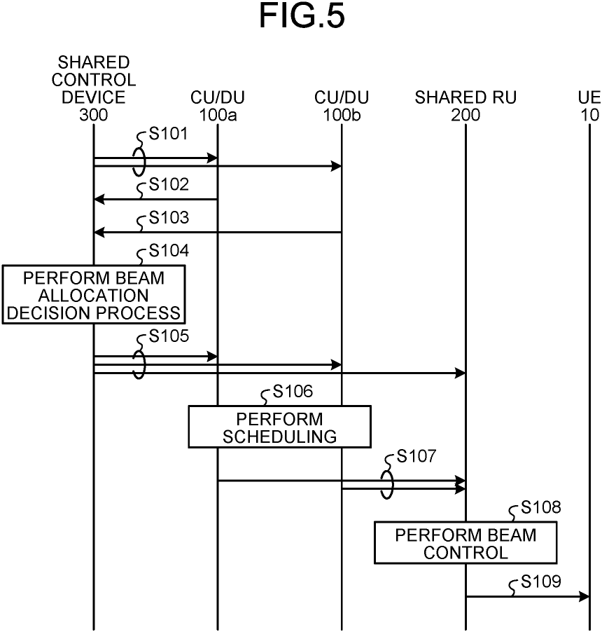

In the following, a communication method used in the wireless communication system constituted as described above will be described with reference to the sequence diagram illustrated in FIG. 5.

The notification request generation unit 321 included in the shared control device 300 generates a notification request that requests a notification of the UE distribution information. The notification request is transmitted to the CU/DUs 100a and 100b (Step S101). The CU/DU 100a that receives the notification request accumulates the number of UEs 10 managed by the own MNO for each beam formed by the shared RU 200, and transmits the UE distribution information that indicates the number of UEs 10 for each beam to the shared control device 300 (Step S102). Similarly, the CU/DU 100b that receives the notification request accumulates the number of UEs 10 managed by the own MNO for each beam formed by the shared RU 200, and transmits the UE distribution information that indicates the number of UEs 10 for each beam to the shared control device 300 (Step S103). Furthermore, in the UE distribution information, in addition to the number of UEs 10 for each beam, information on an amount of traffic to and from the UEs 10 for each beam may be included.

The UE distribution information associated with each of the MNOs is received by the communication I/F unit 310 included in the shared control device 300, and a beam allocation decision process based on the UE distribution information is performed by the beam allocation decision unit 322 (Step S104). That is, the number of UEs 10 for each beam is counted regardless of the MNOs, and a larger number of slots is allocated to the beam in the direction in which a larger number of UEs 10 are present. Then, the beam time information that indicates the allocation time for each beam is generated, and is transmitted to the CU/DUs 100a and 100b and the shared RU 200 (Step S105). Furthermore, the beam allocation decision process performed at Step S104 will be described in detail later.

When the beam time information is received by the communication I/F unit 110 included in each of the CU/DUs 100a and 100b, scheduling based on the beam time information is performed by the scheduler unit 121 (Step S106). That is, scheduling is performed, in the slots in each of which the beam is formed by the shared RU 200, such that the signal addressed to the UE 10 located in the direction of the subject beam is to be transmitted. Then, in accordance with the result of the scheduling, a signal addressed to the UE 10 is generated by the signal generation unit 122, and a transmission signal addressed to each of the UEs 10 is transmitted to the shared RU 200 (Step S107).

In contrast, when the beam time information is received by the communication I/F unit 210 included in the shared RU 200, beam control in accordance with the beam time information is performed by the phase shifter control unit 222 (Step S108). That is, an amount of phase rotation that is set in the phase shifters 280 associated with the plurality of respective antenna elements such that each of the beams is formed in the allocation time. Then, the transmission signal that is addressed to the UE 10 and that has been transmitted from the CU/DUs 100a and 100b is wirelessly transmitted to the UE 10 by using the beam that is formed by the phase shifter 280 (Step S109).

In this way, the allocation time at which each of the beams is formed in accordance with the number of UEs 10 for each beam is decided, and scheduling is performed, on the basis of the allocation time for each beam, on the timing at which the signal addressed to the UE 10 is transmitted. Accordingly, the signals addressed to the UEs 10 located in the same direction of the beam are simultaneously transmitted even if different MNOs manage the UEs 10, so that it is possible to transmit, by sharing the phase shifter 280, the signals addressed to the UEs 10 that are managed by the respective MNOs. As a result, a phase shifter for each MNO is not needed, and it is thus possible to suppress an increase in the size of the shared RU 200.

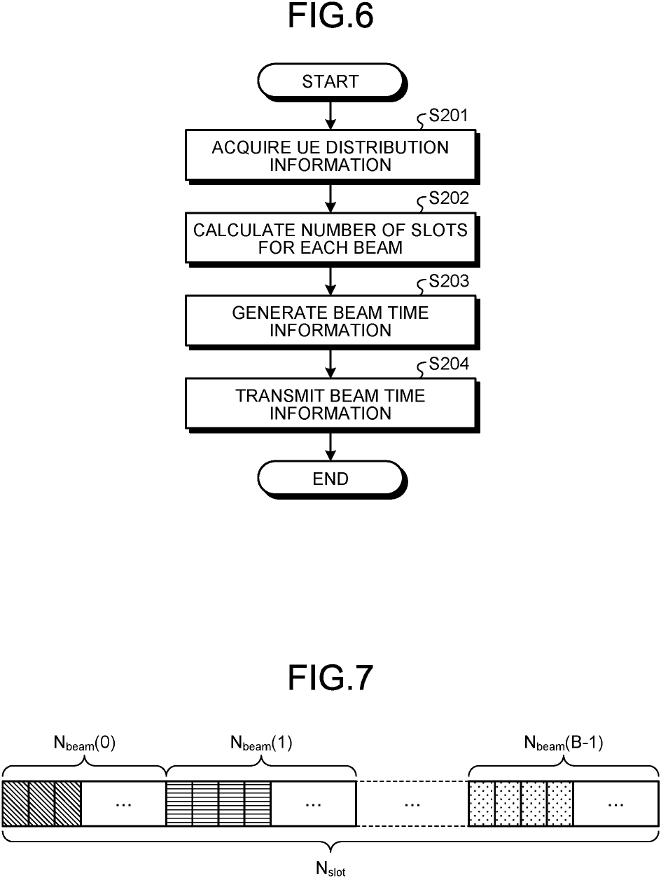

In the following, the beam allocation decision process according to the first embodiment will be specifically described with reference to the flowchart illustrated in FIG. 6. The beam allocation decision process is mainly performed by the beam allocation decision unit 322 included in the shared control device 300.

The shared control device 300 receives the UE distribution information from the CU/DUs 100a and 100b associated with each of the MNOs as a result of the notification request that requests a notification of the UE distribution information being transmitted to the CU/DUs 100a and 100b in a predetermined period. The UE distribution information associated with each of the MNOs is acquired by the beam allocation decision unit 322 (Step S201), and the number of UEs 10 that are associated with each of the MNOs and that are located in the direction of each of the beams formed by the shared RU 200 is specified. Then, the number of slots to be allocated to each of the beams is calculated by using the number of UEs 10 that are associated with each of the MNOs for each beam (Step S202).

Specifically, if the number of UEs 10 associated with a MNO #m in a beam #b is denoted by N_{UE}(m,b), the number of slots N_{beam}(b) to be allocated to the beam #b is calculated by using Equation (1) below.

$${N}_{b e a m} \left(b\right) = i n t \left({N}_{s l o t} \frac{{\sum }_{{m}^{′} ∈ M N O} {N}_{U E} \left({m}^{′} , b\right)}{{\sum }_{{b}^{′} ∈ B e a m} {\sum }_{{m}^{′} ∈ M N O} {N}_{U E} \left({m}^{′} , b\right)}\right) \qquad \text{(1)}$$

where, in Equation (1) above, int(A) denotes a function for converting A to an integer, and Nₛₗₒₜ denotes the total number of slots targeted for allocation to the beam in a predetermined period of time. Furthermore, MNO denotes the set of all of the MNOs that share the shared RU 200, and Beam denotes the set of all of the beams that are formed by the shared RU 200. In this way, the number of slots N_{beam}(b) allocated to the beam #b is decided in accordance with the ratio of the sum of the number of UEs 10 that are associated with each of the MNOs and that are located in the direction of the beam #b to the number of all of the UEs 10. That is, the number of slots N_{beam}(b) allocated to the beam #b is proportional to the number of UEs 10 that are located in the direction of the beam #b.

Furthermore, the number of slots N_{beam}(b) allocated to the beam #b may be calculated by using, for example, Equation (2) below, by denoting an amount of traffic of a UE #u managed by the MNO #m in the beam #b by T(m,b,u).

$$\begin{matrix}{N}_{b e a m} \left(b\right) \\ = i n t \left({N}_{s l o t} \frac{{\sum }_{{m}^{′} ∈ M N O} {\sum }_{{u}^{′} ∈ U E \left({m}^{′}\right)} T \left({m}^{′} , b , {u}^{′}\right)}{{\sum }_{{b}^{′} ∈ B e a m} {\sum }_{{m}^{′} ∈ M N O} {\sum }_{{u}^{′} ∈ U E \left({m}^{′}\right)} T \left({m}^{′} , b , {u}^{′}\right)}\right)\end{matrix} \qquad \text{(2)}$$

where, in Equation (2), UE(m′) denotes the set of all of the UEs 10 managed by a MNO #m′. In this way, the number of slots N_{beam}(b) allocated to the beam #b may be decided in accordance with the ratio of the sum of the amount of traffic of the UEs 10 that are managed by each of the MNOs and that are located in the direction in the beam #b to the amount of traffic of all of the UEs 10. That is, the number of slots N_{beam}(b) allocated to the beam #b may be decided in proportion to the amount of traffic of the UEs 10 that are located in the direction of the beam #b.

Furthermore, the number of slots N_{beam}(b) allocated to the beam #b may be calculated in consideration of the priority of the UEs 10. That is, for example, the priority of a UE #u′ is denoted by w(u′), and by replacing N_{UE}(m,b) and N_{UE}(m,b′) in Equation (1) above with Equation below, it is possible to calculate the number of slots for each beam in accordance with the priority of each of the UEs 10 on the basis of the number of UEs 10 for each beam.

$${N}_{U E} \left({m}^{′} , b\right) = {\sum }_{{u}^{′} ∈ U E \left({m}^{′} , b\right)} w \left({u}^{′}\right)$$

$${N}_{U E} \left({m}^{′} , b\right) = {\sum }_{{u}^{′} ∈ U E \left({m}^{′} , {b}^{′}\right)} w \left({u}^{′}\right)$$

Similarly, by using Equation below instead of Equation (2) above, it is possible to calculate the number of slots for each beam in accordance with the priority of each of the UEs 10 on the basis of the amount of traffic of the UEs 10 for each beam.

$$\begin{matrix}{N}_{b e a m} \left(b\right) \\ = i n t \left({N}_{s l o t} \frac{{\sum }_{{m}^{′} ∈ M N O} {\sum }_{{u}^{′} ∈ U E \left({m}^{′}\right)} w \left({u}^{′}\right) T \left({m}^{′} , b , {u}^{′}\right)}{{\sum }_{{b}^{′} ∈ B e a m} {\sum }_{{m}^{′} ∈ M N O} {\sum }_{{u}^{′} ∈ U E \left({m}^{′}\right)} w \left({u}^{′}\right) T \left({m}^{′} , b , {u}^{′}\right)}\right)\end{matrix}$$

The priority of the UE 10 may be set in accordance with the type of data that is transmitted and received by each of the UEs 10. That is, for example, the priority of the UE 10 that transmits and receives real-time video image data may be set to high, whereas, for example, the priority of the UE 10 that downloads a file may be set to low.

In this way, by calculating the number of slots N_{beam}(b) allocated to the beam #b, for example, as illustrated in FIG. 7, N_{beam}(0) to N_{beam}(B-1) slots are allocated to B beams #0 to # (B-1) (B is an integer greater than or equal to 2), respectively, that are formed by the shared RU 200. Then, the beam time information that indicates the allocation time for each beam is generated (Step S203), and is transmitted from the communication I/F unit 310 to the CU/DUs 100a and 100b and the shared RU 200 (Step S204).

As described above, according to the present embodiment, the shared control device decides, on the basis of the UE distribution information associated with each of the MNOs, the allocation time of each of the beams in accordance with the number of UEs or the amount of traffic of the UEs for each beam, and notifies the CU/DU and the shared RU of the beam time information. Then, the CU/DU performs scheduling on the basis of the beam time information, and the shared RU forms beams in accordance with the beam time information. On account of this, the shared RU simultaneously transmits the signals addressed to the UEs that are located in the same direction of the beam from among the UEs managed by the plurality of MNOs, so that it is possible to share the phase shifter that is used to form beams related to the plurality of MNOs. As a result, a phase shifter for each MNO is not needed and it is thus possible to suppress an increase in the size of the device.

### [B] Second Embodiment

The characteristic of a second embodiment is that the allocation time for each beam is uniformly distributed and transmission timing with respect to each of the UEs is equally disposed.

A configuration of a wireless communication system according to the second embodiment is the same as that described in the first embodiment (FIG. 1); therefore, descriptions thereof will be omitted. Furthermore, configurations of the CU/DUs 100a and 100b, the shared RU 200, and the shared control device 300 according to the second embodiment are the same as those described in the first embodiment (FIGS. 2 to 4); therefore, descriptions thereof will be omitted. In the second embodiment, the beam allocation decision process performed by the beam allocation decision unit 322 included in the shared control device 300 is different from that described in the first embodiment.

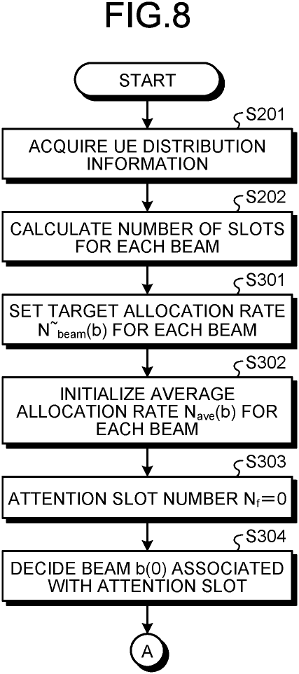

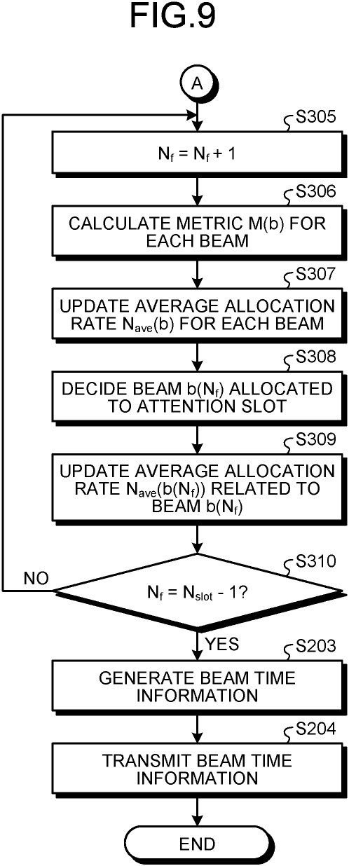

FIGS. 8 and 9 are flowcharts each illustrating the beam allocation decision process according to the second embodiment. In FIGS. 8 and 9, components that are the same as those illustrated in FIG. 6 are assigned the same reference numerals and descriptions thereof in detail will be omitted.

By transmitting the notification request that requests a notification of the UE distribution information to the CU/DUs 100a and 100b in a predetermined period, the UE distribution information associated with each of the MNOs is acquired by the beam allocation decision unit 322 (Step S201). Then, the number of slots allocated to each of the beams is calculated by using the number of UEs 10 or an amount of traffic of UEs 10 associated with each of the MNOs for each beam (Step S202).

When the number of slots allocated to each of the beams is decided, a target allocation rate N^{~}_{beam}(b) is set related to each of the beams (Step S301). That is, by using Equation (3) below, the ratio of the number of slots allocated to the beam #b to the total number of slots Nₛₗₒₜ is calculated, and the obtained ratio corresponds to the target allocation rate N^{~}_{beam}(b) of the beam #b.

$${N}_{b e a m}^{∼} \left(b\right) = \frac{{N}_{b e a m} \left(b\right)}{{N}_{s l o t}} \qquad \text{(3)}$$

When the target allocation rate N^{~}_{beam}(b) is set to all of the beams, an average allocation rate Nₐᵥₑ(b) for each beam is initialized (Step S302). Specifically, by using Equation (4) below, an initial value of the average allocation rate Nₐᵥₑ(b) of the beam #b is calculated.

$${N}_{a v e} \left(b\right) = \frac{{N}_{b e a m}^{∼} \left(b\right) + \left(1 / {N}_{s l o t}\right) ∗ R N D \left(0 , 1\right)}{{N}_{s l o t}} \qquad \text{(4)}$$

where, in Equation (4) above, RND(0,1) denotes a random number between 0 and 1. In this way, the initial value of the average allocation rate Nₐᵥₑ (b) of each of the beams is set by using the target allocation rate N^{~}_{beam}(b) and the random number.

Then, the first slot targeted for allocation to the beam in a predetermined period of time becomes an attention slot, and zero is set as the slot number N_{f} of the attention slot (Step S303). Hereinafter, a beam of an attention slot N_{f} is denoted by beam b(N_{f}). If the attention slot is set to the first slot (N_{f}=0), a beam b (0) associated with the attention slot is decided (Step S304). Specifically, it is decided that the beam #b in which the average allocation rate Nₐᵥₑ(b) is the maximum is a beam b (0).

When the beam b(0) associated with the first slot has been decided, the attention slot moves to the subsequent slot (Step S305). Then, a metric M(b) for each beam is calculated by using Equation (5) below (Step S306).

$$M \left(b\right) = \frac{{N}_{b e a m}^{∼} \left(b\right)}{{N}_{a v e} \left(b\right)} \qquad \text{(5)}$$

The metric M(b) approaches 1 and becomes smaller as the average allocation rate Nₐᵥₑ (b) is closer to the target allocation rate N^{~}_{beam}(b). Therefore, the metric M(b) of the beam is larger as the average allocation rate Nₐᵥₑ(b) is further away from the target allocation rate N^{~}_{beam}(b) .

Furthermore, because the attention slot has been moved, the average allocation rate Nₐᵥₑ(b) of each of the beams is updated (Step S307). That is, by using Equation (6) below, the average allocation rate Nₐᵥₑ(b) of the beams #b is uniformly updated.

$${N}_{a v e} \left(b\right) = \frac{{N}_{f}}{{N}_{f} + 1} {N}_{a v e} \left(b\right) \qquad \text{(6)}$$

Then, by using the metric M(b) calculated at Step S306, the beam b(N_{f}) allocated to the attention slot is decided (Step S308). Specifically, it is decided that the beam #b in which the metric M(b) is the maximum is the beam b(N_{f}).

When the beam b(N_{f}) allocated to the attention slot is decided, the average allocation rate Nₐᵥₑ(b(N_{f})) related to the decided beam b(N_{f}) is updated (Step S309). That is, by using Equation (7) below, the average allocation rate Nₐᵥₑ(b(N_{f})) related to the beam b(N_{f}) is updated.

$${N}_{a v e} \left(b \left({N}_{f}\right)\right) = {N}_{a v e} \left(b \left({N}_{f}\right)\right) + \frac{1}{{N}_{f} + 1} \qquad \text{(7)}$$

Then, it is determined whether or not the last slot targeted for allocation to the beam in the predetermined period of time is the attention slot (Step S310), and, if a slot that has not been assigned to the attention slot still remains (No at Step S310), the attention slot moves to the subsequent slot (Step S305), and a process for deciding the beam b(N_{f}) allocated to the attention slot is repeated.

In this way, for example, as illustrated in FIG. 10, by sequentially allocating the attention slot with the slot number N_{f} to the beam b(N_{f}) in which the metric M(b) is the maximum, it is possible to equally decide the beam allocation such that the average allocation rate Nₐᵥₑ(b) of the beams approaches the target allocation rate N^{~}_{beam}(b). Then, if allocation to beam has been decided up to the last slot (Yes at Step S310), the beam time information that indicates the allocation time for each beam is generated (Step S203), and is transmitted from the communication I/F unit 310 to the CU/DUs 100a and 100b and the shared RU 200 (Step S204).

As described above, according to the present embodiment, the shared control device decides, on the basis of the UE distribution information associated with each of the MNOs, the allocation time for each of the beams such that the allocation time for each beam is uniformly distributed, and notifies the CU/DU and the shared RU of the beam time information. As a result, it is possible to suppress an increase in the size of the device, and also, it is possible to equally dispose the transmission timing with respect to each of the UEs.

### [C] Third Embodiment

The characteristic of a third embodiment is that allocation time of each of the beams is allowed to be present in a retransmission available section and retransmission of data to each of the UEs is allowed.

A configuration of a wireless communication system according to the third embodiment is the same as that described in the first embodiment (FIG. 1); therefore, descriptions thereof will be omitted. Furthermore, configurations of the CU/DUs 100a and 100b, the shared RU 200, and the shared control device 300 according to the first embodiment are the same as those described in the first embodiment (FIGS. 2 to 4); therefore, descriptions thereof will be omitted. In the third embodiment, the beam allocation decision process performed by the beam allocation decision unit 322 included in the shared control device 300 is different from that described in the first embodiment.

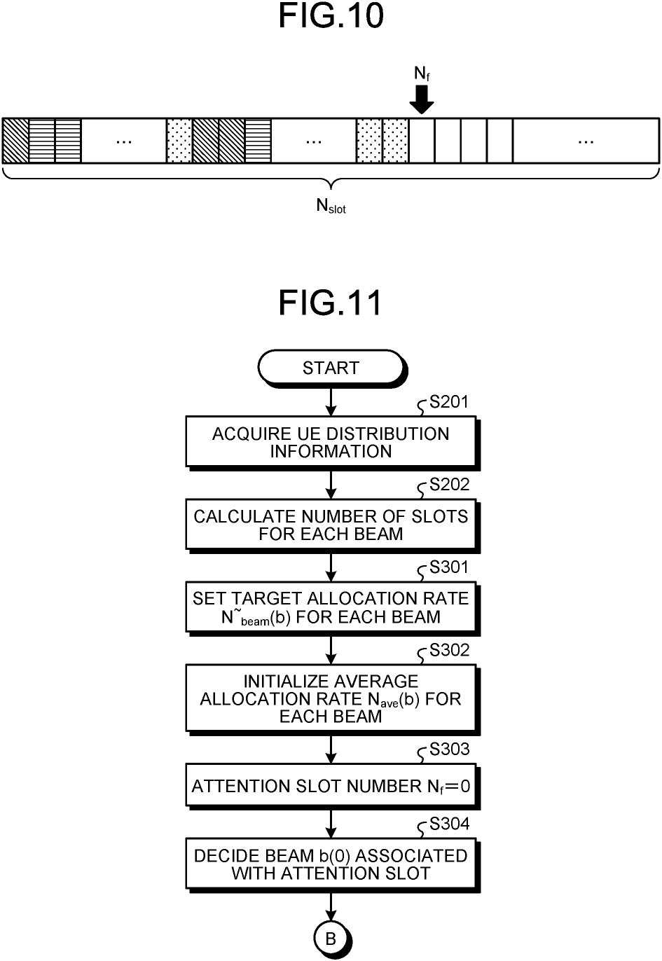

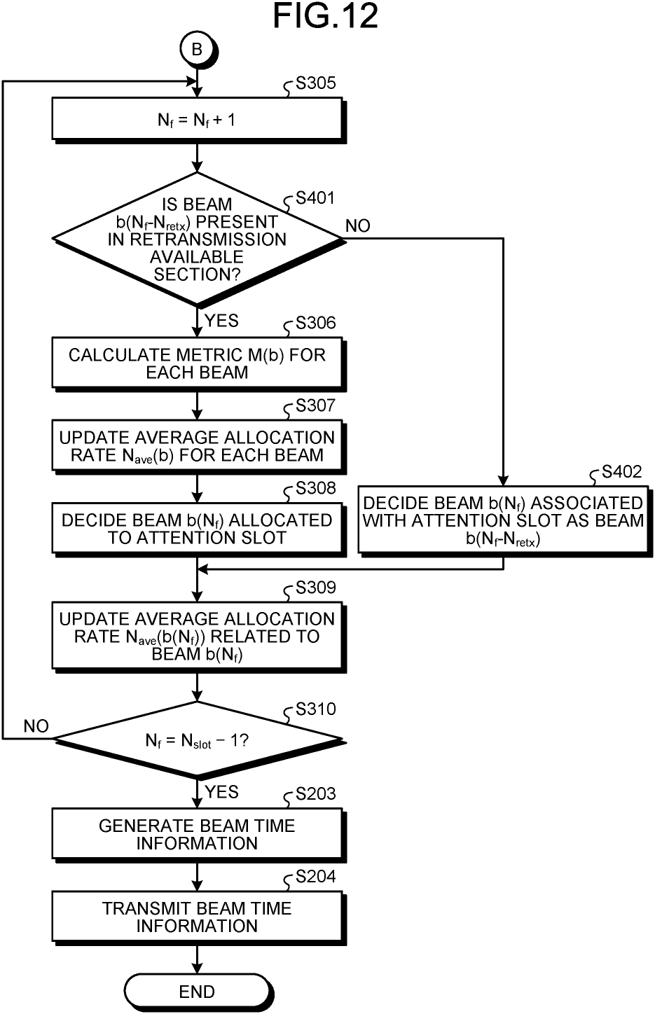

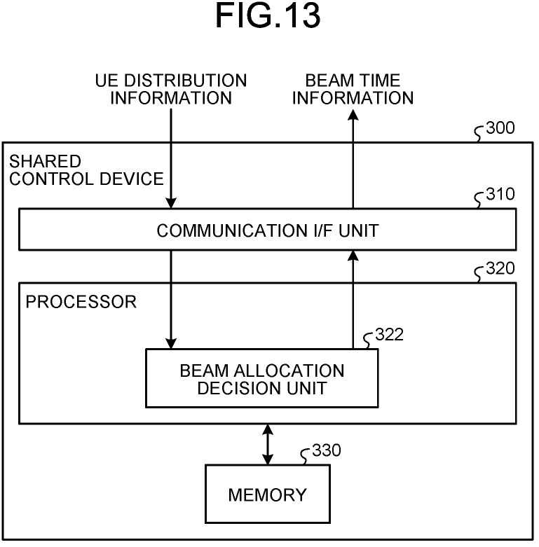

FIGS. 11 and 12 are flowcharts each illustrating the beam allocation decision process according to the third embodiment. In FIGS. 11 and 12, components that are the same as those illustrated in FIGS. 6, 8, and 9 are assigned the same reference numerals and descriptions thereof in detail will be omitted.

By transmitting the notification request that requests a notification of the UE distribution information to the CU/DUs 100a and 100b in a predetermined period, the UE distribution information associated with each of the MNOs is acquired by the beam allocation decision unit 322 (Step S201). Then, the number of slots allocated to each of the beams is calculated by using the number of UEs 10 or using an amount of traffic of UEs 10 associated with each of the MNOs for each beam (Step S202).

When the number of slots allocated to each of the beams has been decided, the target allocation rate N^{~}_{beam}(b) is set to each of the beams by using Equation (3) above (Step S301), and, by using Equation (4) above, the average allocation rate Nₐᵥₑ(b) for each beam is initialized (Step S302). Then, the first slot targeted for allocation to the beam in a predetermined period of time becomes the attention slot, zero is set as the slot number N_{f} of the attention slot (Step S303), and the beam b(0) allocated to the attention slot is decided (Step S304) .

When the beam b(0) associated with the first slot has been decided, the attention slot moves to the subsequent slot (Step S305). Then, a beam b(N_{f}Nᵣₑₜₓ) allocated to a precedence slot that precedes the attention slot by an amount equal to the number of slots Nᵣₑₜₓ that corresponds to the maximum amount of time for which retransmission of the data is allowable is identified, and it is determined whether or not the same beam as the beam b (N_{f}-N_{retX}) is present in the slot that is subsequent to the precedence slot (Step S401). That is, the slots located between immediately after the precedence slot (N_{f}-N_{retX}) and the attention slot N_{f} correspond to the retransmission available section for the data that is transmitted by using the precedence slot (N_{f}=Nᵣₑₜₓ), so that it is determined whether or not the slot included in the retransmission available section is allocated to the same beam as that allocated to the precedence slot (N_{f}-Nᵣₑₜₓ) .

If the result of the determination indicates that the same beam as the beam b (N_{f}-N_{retX}) is not allocated to the slot included in the retransmission available section (No at Step S401), the beam b(N_{f}) allocated to the attention slot is compulsory decided to be the same beam as the beam b(N_{f}-Nᵣₑₜₓ) allocated to the precedence slot (N_{f}-Nᵣₑₜₓ) (Step S402) . Accordingly, the beam that is the same as that allocated to the precedence slot (N_{f}-Nᵣₑₜₓ) is formed in the retransmission available section for the data that is transmitted by using the precedence slot (N_{f}-Nᵣₑₜₓ), and it is thus possible to perform retransmission of the data.

In contrast, in the case where the beam that is the same as the beam b (N_{f}-N_{retX}) is allocated to the slot that is included in the retransmission available section (Yes at Step S401), the metric M(b) for each beam is calculated by using Equation (5) above (Step S306). Furthermore, by using Equation (6) above, the average allocation rate Nₐᵥₑ(b) of each of the beams is updated (Step S307). Then, the beam b(N_{f}) allocated to the attention slot is decided by using the metric M(b) calculated at Step S306 (Step S308).

If the beam b(N_{f}) allocated to the attention slot is compulsory decided or decided by using the metric M(b), the average allocation rate Nₐᵥₑ(b(N_{f})) related to the decided beam b(N_{f}) is updated by using Equation (7) above (Step S309). Then, it is determined whether or not the last slot targeted for allocation to the beam in a predetermined period of time is the attention slot (Step S310), and, if the slot that has not been assigned to the attention slot still remains (No at Step S310), the attention slot moves to the subsequent slot (Step S305), and the process for deciding the beam b(N_{f}) allocated to the attention slot is repeated.

If the allocation to the beam has been decided to the last slot (Yes at Step S310), the beam time information that indicates the allocation time for each beam is generated (Step S203), and is transmitted from the communication I/F unit 310 to the CU/DUs 100a and 100b and the shared RU 200 (Step S204).

As described above, according to the present embodiment, the shared control device decides, on the basis of the UE distribution information associated with each of the MNOs, the allocation time for each of the beams such that at least one same beam is formed within the retransmission available section, and notifies the CU/DU and the shared RU of the beam time information. As a result, it is possible to suppress an increase in the size of the device, and also, it is possible to transmit the retransmission data in the case where retransmission of data to each of the UEs is generated.

Furthermore, in each of the embodiments described above, it is assumed that the CU/DUs 100a and 100b transmit the UE distribution information to the shared control device 300 in accordance with the notification request received from the shared control device 300. However, the CU/DUs 100a and 100b may spontaneously transmit the UE distribution information to the shared control device 300. That is, for example, in the case where the location of the UE 10 managed by the own MNO is changed and the number of UEs 10 associated with each of the beams is greatly changed, the CU/DUs 100a and 100b may transmit the UE distribution information to the shared control device 300.

In this case, the shared control device 300 is able to have a configuration such that, for example, as illustrated in FIG. 13, the shared control device 300 does not include the notification request generation unit 321. Similarly to the case described above in the first to the third embodiments, the shared control device 300 illustrated in FIG. 13 is able to decide, in the beam allocation decision unit 322, the allocation time for each beam by using the UE distribution information.

Furthermore, in each of the embodiments described above, it has been described as an example in which the shared control device 300 is provided as a unit separated from the CU/DUs 100a and 100b and the shared RU 200; however, the shared control device 300 may be integrally constituted with the CU/DUs 100a and 100b or the shared RU 200. In the case where the shared control device 300 is integrally constituted with the CU/DUs 100a and 100b or the shared RU 200, it is also possible to suppress an increase in the size of the CU/DUs 100a and 100b or the shared RU 200.

According to an aspect of an embodiment of the wireless communication system, the communication control device, and the communication device disclosed in the present application, an advantage is provided in that it is possible to suppress an increase in the size of the device.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A wireless communication system comprising:
a wireless communication device that is capable of forming a plurality of beams each facing a different direction; and
a communication control device that controls the wireless communication device, wherein
the communication control device includes
a processor that executes a process including:
acquiring distribution information that indicates a distribution of terminal devices that perform wireless communication with the wireless communication device;
deciding, based on the acquired distribution information, allocation time that is allocated to each of the plurality of beams; and
generating beam time information that indicates the decided allocation time for each beam; and
a transmitter that transmits the beam time information generated by the processor to the wireless communication device.

2. The wireless communication system according to claim 1, wherein the acquiring includes acquiring the distribution information that indicates a number of terminal devices that are located in respective directions of the plurality of beams.

3. The wireless communication system according to claim 2, wherein the deciding includes deciding the allocation time allocated to each of the beams so as to be proportional to the number of terminal devices for each beam.

4. The wireless communication system according to claim 1, wherein the acquiring includes acquiring the distribution information that indicates an amount of traffic of the terminal devices that are located in the respective directions of the plurality of beams.

5. The wireless communication system according to claim 4, wherein the deciding includes deciding the allocation time allocated to each of the beams so as to be proportional to the amount of traffic of the terminal devices for each beam.

6. The wireless communication system according to claim 1, wherein the deciding includes deciding the allocation time allocated to each of the beams in accordance with a priority of the terminal devices for each beam.

7. The wireless communication system according to claim 1, wherein the deciding includes
sequentially setting each of slots included in a predetermined range to an attention slot, and
deciding a beam to be allocated to the attention slot such that an allocation rate for each beam approaches a target allocation rate.

8. The wireless communication system according to claim 7, wherein the deciding includes
determining whether or not a slot included in a retransmission available section that includes slots located between immediately after a precedence slot and the attention slot is allocated to the same beam as that allocated to the precedence slot that precedes the attention slot by the maximum amount of time for which retransmission of data is allowable, and
allocating, when the slot included in the retransmission available section is not allocated to the same beam as that allocated to the precedence slot, the attention slot to the same beam as that allocated to the precedence slot.

9. The wireless communication system according to claim 1, wherein the acquiring includes acquiring, from a plurality of communication devices each belonging to a different telecommunications carriers, the distribution information on the terminal devices that are managed by each of the telecommunications carriers.

10. The wireless communication system according to claim 9, wherein the process further includes requesting the plurality of communication devices from a notification of the distribution information in a predetermined period.

11. A communication control device comprising:
a processor that executes a process including:
acquiring, by using one of a plurality of beams formed by a wireless communication device, distribution information that indicates a distribution of terminal devices that performs wireless communication with the wireless communication device;
deciding, based on the acquired distribution information, allocation time that is allocated to each of the plurality of beams; and
generating beam time information that indicates the decided allocation time for each beam; and
a transmitter that transmits the beam time information generated by the processor to the wireless communication device.

12. A communication device comprising:
a receiver that receives beam time information that indicates allocation time allocated to each of a plurality of beams that are formed by a wireless communication device; and
a processor that executes a process of scheduling, based on the beam time information received by the receiver, transmission timing with respect to a terminal device that performs wireless communication with the wireless communication device by using one of the plurality of beams.

13. A communication device comprising:
a plurality of antenna elements;
a phase shifter that is provided in each of the plurality of antenna elements and that is capable of forming a plurality of beams each facing a different direction;
a receiver that receives beam time information that indicates allocation time allocated to each of the plurality of beams; and
a processor that controls the phase shifter so as to form one of the plurality of beams in accordance with the beam time information received by the receiver.
